(19) United States
(12) Patent Application Publication
(10) Pub. No.: US 2007/0070351 A1
(43) Pub. Date: Mar. 29, 2007

(54) Optical measuring device and image forming apparatus

(75) Inventors: Hiroshi Nou, Kanagawa (JP); Kouichi Sanpei, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/346,150

(22) Filed: Feb. 3, 2006

(30) Foreign Application Priority Data
Sep. 26, 2005 (JP) P2005-277143

(51) Int. Cl. G01N 21/47

(52) U.S. Cl. 356/446

(57) ABSTRACT

An optical measuring device measures optical characteristics of an object in a non-contact state. The optical measuring device has a light source that illuminates an object surface, a light receiver that receives a light beam reflected from the object surface, and a light-regulating member that regulates an illuminating light beam radiated onto the object surface and the reflective light beam reflected from the object surface. The light-regulating member has a first light-regulating member that determines at least one of an illuminating region and a reflective region with respect to the object surface, and a second light-regulating member that determines a region where the reflected light beam that is reflected from the object surface and is incident on the light receiver is measured on the object surface.

### CROSS-REFERENCE TO RELATED APPLICATIONS

This application is based upon and claims the benefit of priority from the prior Japanese Patent Applications No. 2005-277143, filed on Sep. 26, 2005, the entire contents of which are incorporated herein by reference.

### BACKGROUND OF THE INVENTION

1. Field of the Invention

The present invention relates to an optical measuring device that optically measures colors or the like of images formed or printed by an image forming apparatus such as a copy machine or a printer using a electronic photograph technology or the like.

2. Description of the Related Art

JP-B-2518822, JP-A-2001-343287, and JP-A-10-175330 are referred to as related art.

Generally, most of optical measuring devices are contact type in which colors are measured while the optical measuring device is in contact with an object to be measured (measuring object). For example, a handy type of measuring device such as X-Rite 938 (product name) or SpectroLino (product name) of GretagMacbeth Co., which has been currently most commonly used in the business, is also a manual contact type, and thus, high-speed operation or automation is difficult. Furthermore, examples of the optical measuring devices include automatic color measuring devices such as, for example, SpectroScan of GretagMacbeth Co. in which a handy machine and an XY stage are combined. In theses devices, however, moving the measuring points requires horizontal movements of the measuring devices and vertical movements of the measuring devices for contacting the samples so as to hinder the high-speed measurement. Also, the contact type of optical measuring device has the problem in that the contacting surfaces might be damaged or the measuring objects are limited because the device contacts the samples.

In contrast, non-contact type optical measuring devices are suitable for high-speed and automatic color measurements because only horizontal movements of measuring heads or sample tables are needed.

However, the non-contact type optical measuring devices have the problem in that the distance to the measuring surface is easily changed, and the change in the distance may affect the measurement values. In particular, when a printed material is measured, the effect of floating print paper becomes significant, and thus, adsorbing the paper to the sample table has been considered. The major types of adsorbing methods that adsorb the paper to the sample table include an electrostatic adsorbing method that adsorbs the paper to the sample table in an electrostatic manner, and a vacuum sucking method that sucks the paper by air.

When the paper is adsorbed to the sample table, from the conventional concept that colors are taken as the physical quantity, the backing at the time of measurement is set to black in order to make the reflective light from the back face substantially zero. Thus, it has been typical to make the surface of the sample table having the adsorbing function black.

However, the current perspective is that measuring the colors close to the sense of people is preferable, and the measurement values taken under the condition which is close to the condition that the real printed material is viewed, that is, the measurement value taken under the condition that plural sheets of papers overlap is becoming more and more important. As a result, the trend in the recent industry standard, etc., is to perform measurements under the condition that same type of sheets of paper is stacked under the sample. Therefore, there has been a problem in that it is difficult to adsorb the paper to the sample table by the above-described adsorbing method, and an additional countermeasure is required.

Several techniques to solve the above-mentioned problems have been proposed including, for example, JP-B-2518822, JP-A-2001-343287, and JP-A-10-175330.

The non-contact reflectance measuring device according to JP-B-2518822, as shown in FIG. 12, includes a light source 111 that illuminates the illuminating region b on the object 110, and a measuring device 114 that detects the light beam reflected from the measuring surface m on the object 110. The measuring surface m is smaller than the illuminating region b, and the object is a movable object having a variable distance with respect to the optical system. The light source 111 is disposed at a focal point of a condensing lens 112 for generating a parallel light flux, and the strength of the illumination on the object 110 does not depend on the distance only at the interior of the core region of the illumination region on the basis of the expansion of the light source 111. Furthermore, the optical member 114a of the measuring device 114 has a restricting surface 114a and a lens 113 disposed between the restricting surface 114a and the object 110. Thereby, the size of the measuring surface m is fixed, and the size and the location of the measuring surface m is determined such that the measuring surface is located within the core region with regard to the entire distance changes of the object 110 with respect to the measuring device 114 in a predetermined interval.

Furthermore, the optical measuring device according to JP-A No. 2001-343287 is directed to an optical measuring device that radiates a light beam to a measuring object, condenses the reflective light beam from the measuring object by means of a condensing lens, and measures the characteristic of the object by detecting the quantity of light by a light-receiving element provided near the focal point of the condensing lens. The optical measuring device further includes a member provided near the condensing lens so as to include at least part of the transmissive region located at a periphery of the condensing lens in a direction crossing the optical axis of the condensing lens, and a prohibiting section that is provided on at least partial region including the optical axis side surface of the member for prohibiting the reflection.

Furthermore, the optical measuring method according to JP-A No. 10-175330 uses a light source, a lens, and an photoelectric conversion element that are disposed such that the relative locations are constant each other. The method includes radiating the light beam from the light source to the measuring object, receiving the reflective light from the measuring object by the photoelectric conversion element via the lens, and measuring the characteristic of the measuring object from the light-receiving output of the photoelectric conversion element. The method further includes setting, on the focal surface of the lens at the photoelectric conversion element side, a specific region which is an arbitrary part of the reflective light from the measuring object that comes passing through the lens, receiving only the entire light reflected in an angle range corresponding to the specific region from the measuring object by the photoelectric conversion element via the lens, and putting the total quantity of light received by the photoelectric conversion element as the output of the photoelectric conversion element.

However, the related art have the following problems. Specifically, in the non-contact type reflectance measuring device according to JP-B-2518822, as shown in FIG. 12, although the strength of the illumination of the measuring surface is generally uniformly maintained by making the illuminating light a parallel light beam through the point light source 111 and the condensing lens 112, so that the device is not affected by the change in distance. However, since a perfect point light source 111 does not exist, the effect of change in distance cannot be avoided. Furthermore, the device adopts the structure in which the illuminating light is radiated over a wide range, and the measuring area m of the measuring surface is limited by the light-receiving lens 113 and the edge 114a of the light-receiving fiber 114. However, since the illuminating range b is wide and the distance from the measuring surface to the light-receiving lens 113 is long, the reflective light 120 from the exterior of the measuring area m may be incident as stray light, thereby generating errors. In particular, when the periphery of the measuring patch m is white, the strength of stray light becomes strong, which is problematic.

Furthermore, even in the optical measuring device disclosed in JP-A No. 2001-343287 or JP-A No. 10-175330, although the technology disclosed in JP-A No. 2001-343287 provides a light absorbing member which absorbs the stray light, the technology has the problem in that the effect of the stray light from the periphery of the measuring patch is easier to be received.

In order to eliminate the effect of the stray light, as shown in FIG. 13, the structure of providing an aperture near the measuring surface 204 is effective. In the drawing, the light beam from a light source, which is not shown, is radiated onto the measuring surface 204 of the measuring object 203 via the illuminating lenses 201 and 202, and the reflective light 205 from the measuring object 203 is received by the photoelectric conversion element, which is not shown, via a light-receiving lens 206. However, if the distance H from the aperture surface to the measuring surface 204 is changed, the area of the shadow of the aperture provided on the measuring surface 204 is also changed. Therefore, as shown in FIG. 14, the brightness of the measuring surface 204 is significantly changed, and thus, measuring errors will occur.

### SUMMARY OF THE INVENTION

The present invention has been made in view of the above circumstances and provides an optical measuring device in which, even when the distance from a light source to a measuring object is changed, a light-receiving region can be uniformly maintained so that the effect of change in distance can be avoided, and stray light can be prevented from being introduced from the outside of a measuring area to cause errors so that the measuring precision can be improved.

According to an aspect of the present invention, an optical measuring device measures optical characteristics of an object in a non-contact state. The optical measuring device has a light source that illuminates an object surface, a light receiver that receives a light beam reflected from the object surface, and a light-regulating member that regulates an illuminating light beam radiated onto the object surface and the reflective light beam reflected from the object surface. The light-regulating member has a first light-regulating member that determines at least one of an illuminating region and a reflective region with respect to the object surface, and a second light-regulating member that determines a region where the reflected light beam that is reflected from the object surface and is incident on the light receiver is measured on the object surface.

According to another aspect of the present invention, an image forming device which forms an image on a recording medium includes an image carrier that carries an electrostatic latent image, a developing section that develops the latent image on the image carrier to form a toner image, a transfer section that transfers the toner image onto the recording medium, a fixing section that fixes the toner image transferred onto the recording medium, and an optical measuring section that measures optical characteristics of an image including the toner image fixed on the recording medium in a non-contact state. The optical measuring section includes a light source that illuminates an image surface including the toner image, a light receiver that receives a light beam reflected from the image surface, and a light-regulating member that regulates an illuminating light beam radiated onto the image surface and the reflective light beam reflected from the image surface. The light-regulating member has a first light-regulating member that determines at least one of an illuminating region and a reflective region with respect to the image surface, and a second light-regulating member that determines a region where the light beam that is reflected from the image surface and is incident on the light receiver is measured on the image surface.

With the optical measuring device and the image forming device according to the above aspects, even when the distance from the light source to the measuring object is changed, the light-receiving region can be always uniformly maintained so that the effect of change in distance can be avoided, and stray light can be prevented from being introduced from the outside of the measuring area to cause errors so that the measuring precision can be improved.

### BRIEF DESCRIPTION OF THE DRAWINGS

FIG. 1 is a schematic cross sectional structural diagram showing an optical measuring device according to a first exemplary embodiment of the present invention;

FIG. 2 is a structural diagram showing a high-speed printer as an image forming apparatus to which the optical measuring device according to the first exemplary embodiment of the present invention is applied;

FIG. 3 is a cross sectional structural diagram showing the optical measuring device according to the first exemplary embodiment of the present invention;

FIG. 4 is a structural diagram showing an aperture of the optical measuring device according to the first exemplary embodiment of the present invention;

FIG. 5 is a perspective structural diagram showing the aperture of the optical measuring device according to the first exemplary embodiment of the present invention;

FIG. 6 is a diagram illustrating the effect of the optical measuring device according to the first exemplary embodiment of the present invention;

FIG. 7 is a graph illustrating the effect of the optical measuring device according to the first exemplary embodiment of the present invention;

FIG. 8 is a structural diagram showing an image forming apparatus to which an optical measuring device according to a second exemplary embodiment of the present invention is applied;

FIG. 9 is a schematic cross sectional structural diagram showing the optical measuring device according to the second exemplary embodiment of the present invention;

FIG. 10 is a schematic cross sectional structural diagram showing a modification of the optical measuring device according to the second exemplary embodiment of the present invention;

FIG. 11 is a diagram illustrating a method of measuring colors;

FIG. 12 is a diagram illustrating the effect of an optical measuring device as a related art;

FIG. 13 is a structural diagram showing another optical measuring device as a related art; and

FIG. 14 is a graph showing the relationship between the distance H between the optical measuring device shown in FIG. 13 and the measuring object and the brightness.

### DETAILED DESCRIPTION OF THE INVENTION

Hereinafter, the embodiments of the present invention will be described with reference to the accompanying drawings.

### FIRST EXEMPLARY EMBODIMENT

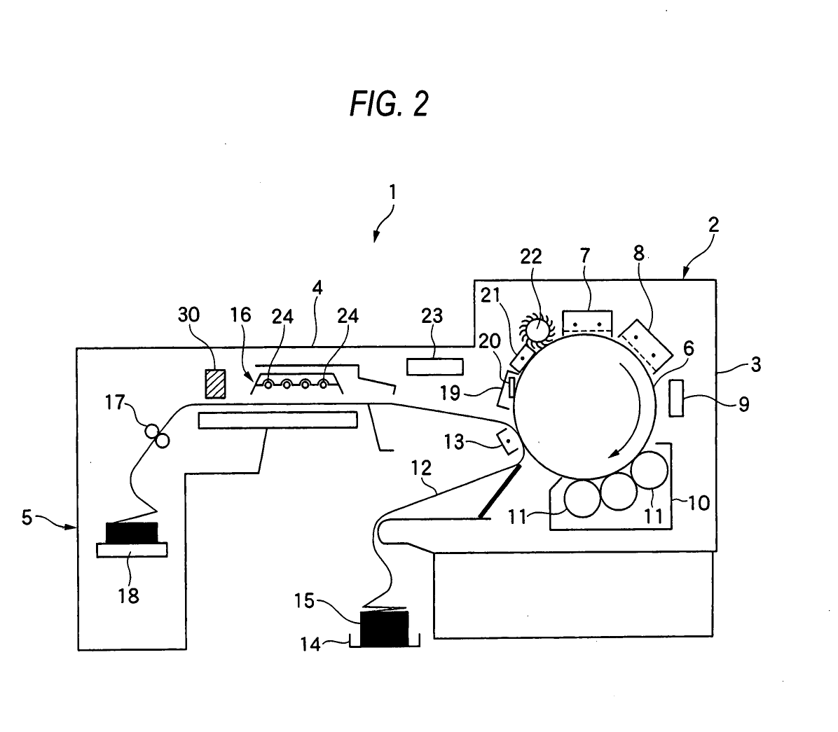

FIG. 2 is a diagram showing a high-speed printer as an image forming apparatus to which the optical measuring device according to the first exemplary embodiment of the present invention is applied.

As shown in FIG. 2, a high-speed printer 1 is capable of printing images at a high speed on continuous paper as a recording medium which is a series of continuous long sheet of paper and partitioned by folding sections (perforations) per one page. A printer main body 2 of the high-speed printer 1 includes an image forming section 3 located at the right side, a fixing section 4 located at the center side, and a paper discharging section 5 located at the left side. In the image forming section 3 of the printer main body 2, a photosensitive drum 6 serving as an image carrier is rotatably disposed such that it can rotate at a high speed along the direction indicated by the arrow. The diameter of the photosensitive drum 6 is set to as large as about 240 mm. The photosensitive drum 6 is composed of an electrically conductive cylindrical body which is coated with a photosensitive layer made of an optically conductive material such as OPC or amorphous-Si or Se, etc. On the top and the oblique right side of the photosensitive drum 6, two primary chargers 7 and 8 are disposed, which are made of scorotrons that uniformly charge the surface of the photosensitive drum 6 with a predetermined potential. Also, at the right side of the photosensitive drum 6, on the surface of the photosensitive drum 6 which is uniformly charged with a predetermined potential by the pair of primary chargers 7 and 8, an LED print head 9 is disposed in which it is equipped with an LED array serving as an image exposing section for exposing images in accordance with image information. The surface of the photosensitive drum 6 is subjected to an image exposure process by the LED printer head 9, and electrostatic latent images according to the image information are formed on the surface of the photosensitive drum 6.

The electrostatic latent images formed on the surface of the photosensitive drum 6 are developed by a developing device 10 disposed under the oblique right side to the lower side of the photosensitive drum 6, and form toner images made from powder toners. Three developing rolls 11 are disposed on the developing device 10 such that the electrostatic latent images formed on the photosensitive drum 6 can be developed at a high speed so as to correspond to the photosensitive drum 6 rotating at a high speed. It should be noted that the developing device 10 might adopt either a one-component developing type or two-component developing type.

Furthermore, a transfer charger 13 composed of corotron, which serves as a transfer section that transfers the toner image formed on the photosensitive drum 6 to the long paper 12 serving as a recording medium, is disposed below the oblique left side of the photosensitive drum 6. The toner images formed on the photosensitive drum 6 are charged by the transfer charger 13 and are then sequentially transferred to the long paper 12.

The long paper 12 serving as a recording medium is fed from a paper feeding section 14 disposed at the inner side of the lower end of the image forming section 3 of the printer main body 2. The long paper 12 is a series of continuous long sheet of paper, and is partitioned by folding sections (perforations) per one page. As shown in the drawing, a set 15 of the continuous long sheet of paper 12 is disposed in the paper feeding section 14 in a folded state.

In accordance with user' needs, the long sheet of paper 12 can be various types of paper such as normal paper, paper thinner than the normal paper, thick paper, coated paper which is made by performing coating on a surface of the normal or thick paper, or paper colored by a predetermined color such as yellow or the like. That is, seven, eight, or more types of paper are prepared as the long sheet of paper 12.

As shown in FIG. 2, the long paper 12 to which toner images have been transferred from the photosensitive drum 6 by the transfer charger 13 is carried to the fixing section 4 by a carrying section which is not shown herein. The unfixed toner images are fixed on the long paper 12 by a flash fixing device 16 mounted in the fixing section 4. In the meantime, although the long sheet of paper 12 is continuously carried, it may also be configured that an accommodating section for temporarily accommodating the long sheet of paper 12 is provided upstream of the flash fixing device 16, and the flash fixing device 16 performs a fixing process on the long paper 12 between the times the long sheet of paper 12 is intermittently carried.

Furthermore, downstream of the flash fixing device 16, an optical measuring device that optically measures the images formed on the long sheet of paper 12 is provided.

In addition, the long sheet of paper 12 on which the unfixed toner images are fixed by the flash fixing device 16 is discharged in a folded state on a paper discharge tray 18 provided in the paper discharge section 5 by the carrying roll 17.

After the transfer of the toner image is finished, residual toner on the surface of the photosensitive drum 6 is removed by a cleaning blade 20 of a cleaning device 19. Residual charge is then discharged by a static eliminator 21 which includes a corotron, and paper or toner powder is cleaned by a cleaning brush 22. Thus making the photosensitive drum 6 ready for the next image forming process.

In FIG. 2, the reference numeral 23 depicts a flashing control unit for controlling the light emission (emission frequency) of a flash lamp 24, which will be later described, of the flash fixing device 16.

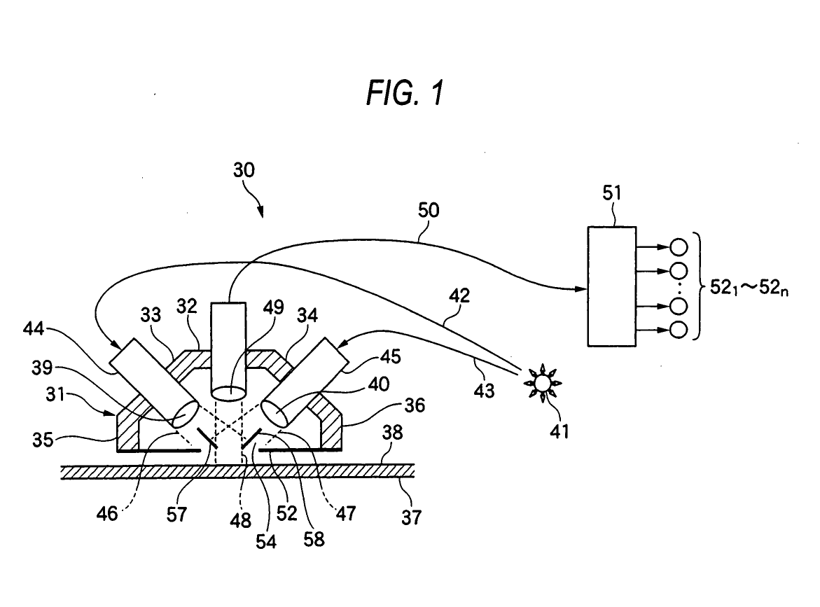

As shown in FIG. 1, the optical measuring device 30 according to the present embodiment includes a measuring device body 31 having a cross section of a substantially half-polygonal shape. The measuring device body 31 has a ceiling wall 32, left and right slanted walls 33 and 34 extending from both ends of the ceiling wall 32 while being slanted at an angle of 45°, and left and right vertical walls 35 and 36 extending from lower ends of the left and right slanted walls 33 and 34, which are made of a metal or synthetic resin, etc.

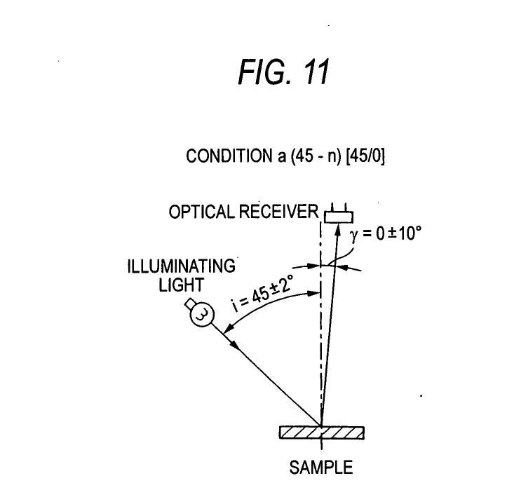

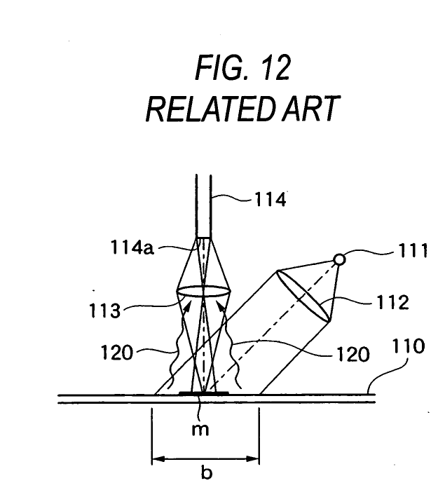

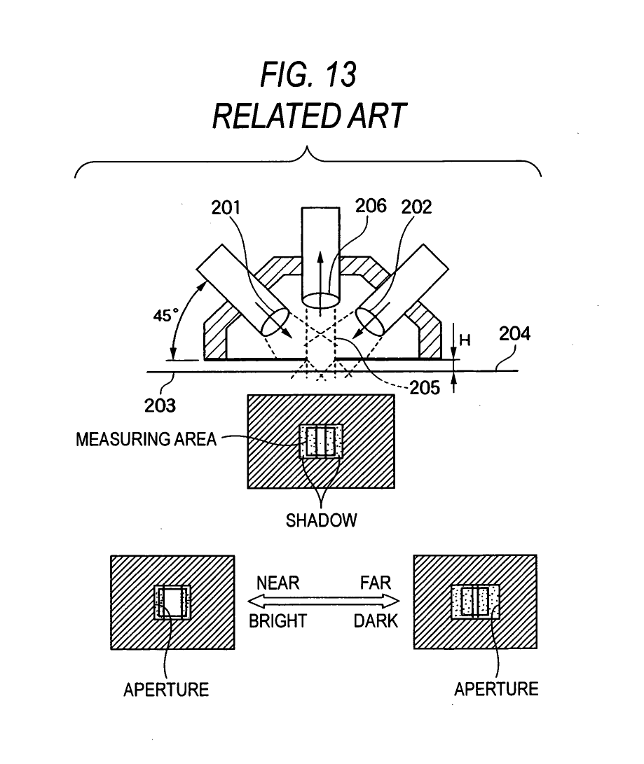

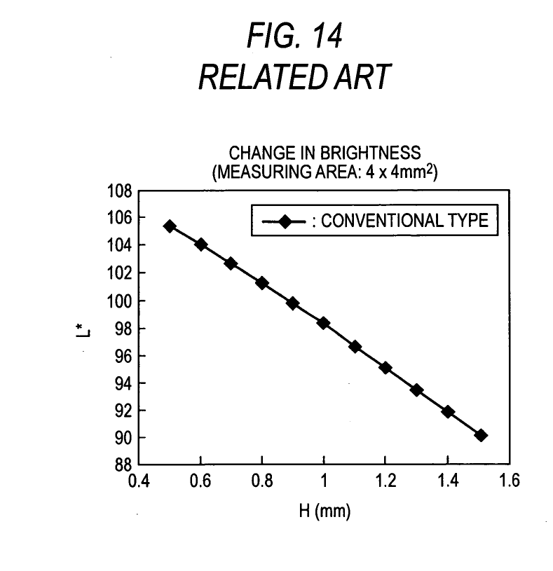

A method of measuring colors is defined in JIS Z8722. In the optical measuring device 30 as in the invention, as shown in FIG. 11, one condition, a (45−n) in 5.3.1 in JIS Z8722, in which the illuminating light is measured at an incident angle i=45±2°, and the reflective light is measured at a reflective angle r=0±10° is employed.

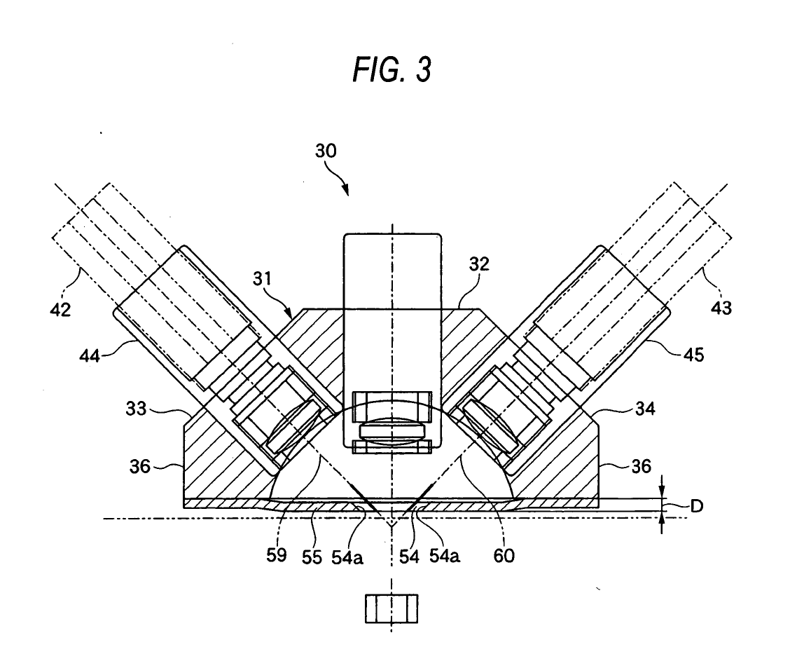

As shown in FIGS. 1 and 3, a first illuminating lens 39 and a second illuminating lens 40 for illuminating the measuring surface 38 of the measuring object 37 at an oblique angle 45° are disposed on the right and left slanted walls 33 and 34 of the measuring device body 31. The first and second illuminating lenses 39 and 40 are configured so that the light beam from the light source 41 composed of an LED or white light lamp that illuminates the measuring object is guided by optical fibers 42 and 43. As shown in FIG. 3, the first and second illuminating lenses 39 and 40 and the optical fibers 42 and 43 are mounted in cylindrical casings 44 and 45. Front ends of the optical fibers 42 and 43 are disposed to be located at predetermined positions with respect to the first and second illuminating lenses 39 and 40. Hence, the illuminating light beams 46 and 47 emitted from the optical fibers 42 and 43 are radiated on the measuring surface 38 of the measuring object 37 as substantially parallel light beams by the first and second illuminating lenses 39 and 40.

Furthermore, as shown in FIGS. 1 and 3, a light-receiving lens 49 for receiving the reflective light 48 from the measuring object 37 is disposed on the ceiling wall 32 of the optical measuring device body 31 directly above (in the vertical direction) the measuring surface 38 of the measuring object 37. The light beam 48 received by the light-receiving lens 49 is guided to a spectroscope 51 through an optical fiber 50, and is then divided by the spectroscope 51 to be received by light-receiving elements 52₁, 52₂, . . . , and 52ₙ. For example, the spectroscope 51 is configured such that the light beam 48 received by the light-receiving lens 49 and guided through the optical fiber 50 is divided into three colors including R (red), G (green), and B (Blue), or plural light beams according to wavelengths by means of filters or prisms (not shown). The invention, however, is not limited thereto, and may be configured to divide the light beam into other colors. Furthermore, the spectroscope 51 may be omitted depending on the object to be measured by the optical measuring device 30.

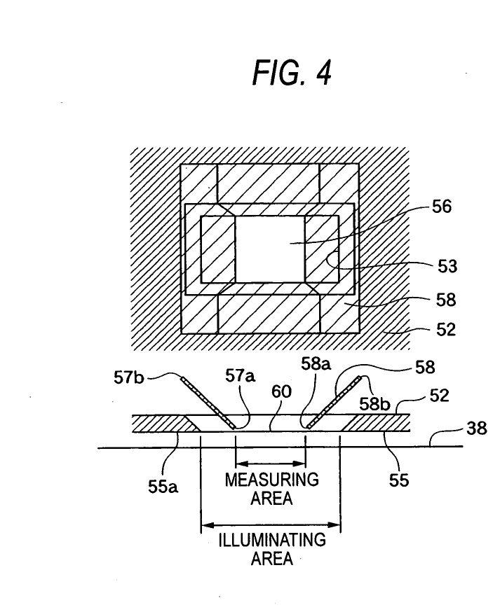

Furthermore, as shown in FIGS. 1 and 3, on the bottom surface of the optical measuring device body 31, a main aperture 52 is provided as a first light-regulating member having an opening portion 54 that controls the illuminating light beams 46 and 47 radiated on the measuring surface 38 of the measuring object 37. As shown in FIG. 3, the main aperture 52 is formed of a thin plate which is made of a metal such as stainless steel or a synthetic resin whose both surfaces are colored with black. In the main aperture 52, the opening portion 54 is provided to control the radiated area 53 of the illuminating light beams 46 and 47 radiated from the first and second illuminating lenses 39 and 40. As shown in FIG. 4, the radiated area 53 has a rectangular shape of, for example, 8 mm×4 mm.

More specifically, the main aperture 52 is, as shown in FIGS. 3 and 4, formed of a thin plate (thickness of about 1.5 mm) which is made of stainless steel whose both surfaces are colored with black, for instance. The portion 55 of the main aperture 52 located in the optical measuring device body 31 is folded to approach the measuring surface 38 of the measuring object 37 through a bending portion 55a such that it is parallel to the bottom surface of the optical measuring device body 31 by a distance D of about 2 mm. Furthermore, as shown in FIG. 3, an edge portion 54a of the opening portion 54 of the main aperture 52 is cut at an angle of 45° to keep the edges of the illuminating light beams 46 and 47 as clear as possible.

Furthermore, as shown in FIGS. 1, 3 and 4, sub-apertures 57 and 58 are formed in the optical measuring device body 31 as second light-regulating members for determining the measuring area 56 of the reflective light 48 which is reflected from the measuring surface 38 of the measuring object 37 and is incident on the light-receiving element 52. The sub-apertures 57 and 58 are formed of thin plates which are made of a metal such as stainless steel or synthetic resin whose both surfaces are colored with black, and each of their thickness is set much thinner than that of the main aperture 52, for example, about 0.1 mm, in order to block the illuminating light beams 46 and 47 at its minimum level. Two sub-apertures 57 and 58 are provided so as to correspond to the first and second illuminating lenses 39 and 40.

As shown in FIGS. 3 and 4, the first and second sub-apertures 57 and 58 are disposed at the locations corresponding to the opening portion 54 of the main aperture 52 while being slanted by 45° and parallel to the respective optical axes 59 and 60 of the illuminating light beams 46 and 47.

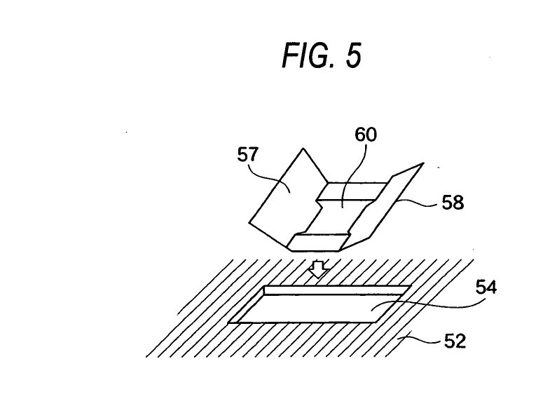

More specifically, as shown in FIG. 5, the first and second sub-apertures 57 and 58 are integrally formed by bending, for example, by means of pressing, the thin plate (thickness of about 0.1 mm) made of, for example, stainless steel whose both surfaces are colored with black. The first and second sub-apertures 57 and 58 are disposed such that their lower portions 57 and 58 are on the same plane as end portions 57a and 58a of the main aperture 52 at the measuring surface 38 side, that is, as the bottom surfaces 55a of a protrusion 55 of the main aperture 52.

Furthermore, as shown in FIG. 4, an opening portion 60, which restricts the reflective light beam 48, and as a result, determines the measuring area 56, is provided in the first and second sub-apertures 57 and 58. The region of the reflective light beam 48 (measuring area 56) reflected on the measuring surface 38 and incident on the light-receiving lens 49 is restricted by the end portions 57a and 58a of the opening portion 60. Furthermore, the other end portions 57b and 58b of first and second sub-apertures 57 and 58 are formed to protrude more toward the outside than the edge portions 54a and 54b of the opening portion 54 of the main aperture 52 so as to shield the reflective light beam 48 passing through the opening 54 of the main aperture 52. The measuring area 56 is formed of, for example, a square shape of 4 mm×4 mm.

In the present embodiment, according to the above-mentioned configuration, even when the distance from the light source to the measuring object is changed, the light-receiving region can be uniformly maintained, so that the effect of change in distance can be avoided, and stray light can be prevented from being introduced from the outside of the measuring area to cause errors, thereby improving the measuring precision.

That is, as shown in FIG. 2, in the high-speed printer 1 to which the optical measuring device 30 according to the present embodiment is applied, toner images are formed on the photosensitive drum 6 in accordance with image information, and the toner images formed on the photosensitive drum 6 are transferred to the long sheet of paper 12, and then the unfixed toner images are fixed on the long sheet of paper 12 by the flash fixing device 16 to form an image.

At this time, the images are formed at a high speed on the continuous long sheet of paper 12 in the high-speed printer 1. Therefore, if an error in resolution, gradation, or the like, occurs in the images formed on the continuous long sheet of paper 12, a large amount of defective printed materials are generated.

In the present embodiment, the optical measuring device 30 for optically measuring the image formed on the long sheet of paper 12 in a non-contact state is disposed downstream of the flash fixing device 16. Although the optical measuring device 30, which is a non-contact type, can perform the measurement without depending on the measuring object, in such non-contact type of measuring device, the distance to the measuring object 37 might be changed due to its non-contact characteristic.

In the above-described optical measuring device 30, however, as shown in FIG. 1, the light beam emitted from the light source 41 is guided to the first and second illuminating lenses 39 and 40 through the optical fibers 42 and 43, and the light beam emitted from the light source 41 is made to be substantially parallel light beams 46 and 47 by the first and second illuminating lenses 39 and 40 to radiate the measuring surface 38 of the measuring object 37.

At this time, as shown in FIGS. 3 and 4, the above-described optical measuring device 30 includes a main aperture 52 that has an opening portion 54 between the first and second illuminating lenses 39 and 40 and the measuring surface 38 of the measuring object 37. Therefore, the illuminating light beams 46 and 47 radiated from the first and second illuminating lenses 39 and 40 are restricted (shielded) by the main aperture 52, and, on the measuring surface 38 of the measuring object 37, the radiated area 53 formed in a rectangular shape of 8 mm×4 mm is illuminated, as shown in FIG. 4.

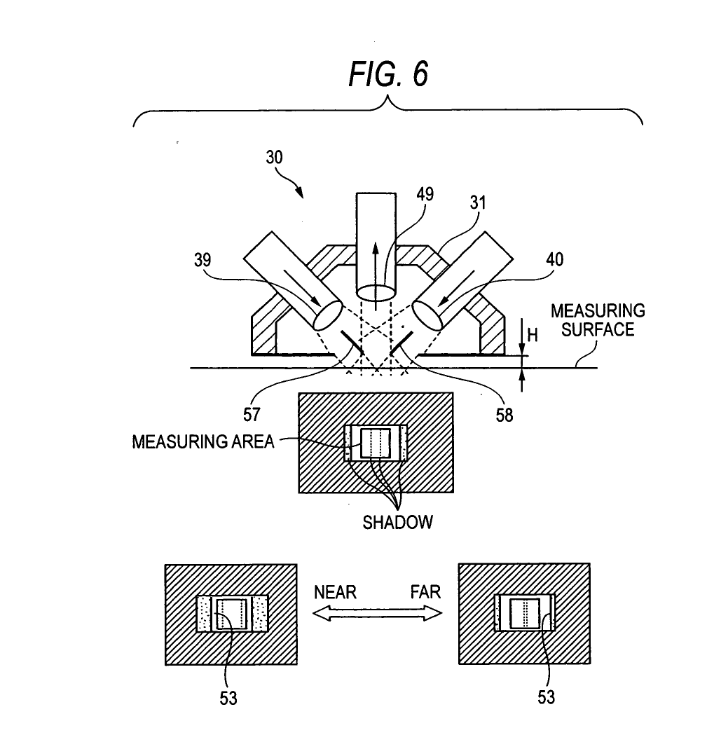

However, as shown in FIG. 6, in the above-described optical measuring device 30, if the distance H between the optical measuring device 30 and the measuring surface 38 of the measuring object 37 is changed, the radiated area 53 on the measuring surface 38 of the measuring object 37 is changed. Also, two linear shadows in FIG. 6 indicate the shadows of the first and second sub-apertures 57 and 58. These shadows of the first and second sub-apertures 57 and 58 are narrow linear shape, and do not affect the measurement.

In the meantime, as shown in FIG. 6, the optical measuring device 30 according to the present embodiment includes the first and second sub-apertures 57 and 58 that determine the measuring area 56 by the light-receiving lens 49 which are separate from the main aperture 52. The first and second sub-apertures 57 and 58 restrict the reflective light 48 illuminated by the illuminating light beams 46 and 47 and reflected from the measuring surface 38 of the measuring object 37 to become the measuring area 56 which is narrower than the radiated area 53. In addition, since the light-receiving lens 49 that receives the reflective light 48 is mounted directly above (in the vertical direction) the measuring surface 38, the reflective light 48 becomes a light beam that is reflected substantially perpendicular to the measuring surface 38 of the measuring object 37.

Therefore, even though the surface of the long sheet of paper 12, which is the measuring surface 38 of the measuring object 37, moves upward or downward due to the positional change, since the reflective light 48 is reflected substantially perpendicular to the measuring surface 38 of the measuring object 37, the edge of the reflective light 48 is restricted by the edges 57a and 58a of the first and second sub-apertures 57 and 58, and the size of the measuring area 56 is not changed.

Accordingly, in the optical measuring device 30, the reflective light 48 is received by the light-receiving lens 49 through the measuring area 56 which is always the same size, even though the distance H between the optical measuring device 30 and the measuring surface 38 of the measuring object 37 is changed. The reflective light 48 received by the light-receiving lens 49 is guided to the spectroscope 51 through the optical fiber 50, divided by the spectroscope 51, and received by the light-receiving elements 52. The light-receiving elements 52 can convert it to electrical signals, and by using a desired color system such as Lab, optically measure the chromaticity or density, etc., of the reflected light 48.

Moreover, the effect of change in distance can be avoided, and stray light can be prevented from being introduced from the outside of the measuring area 56 to cause errors, and thus, the measuring precision can be improved.

### EXPERIMENTAL EXAMPLE

Next, to confirm the effect of the invention, the inventors of the invention manufactured a prototype device of the optical measuring device 30 shown in FIGS. 1 and 3, and conducted an experiment to measure how the brightness L of the reflective light received by the light-receiving elements 52 is changed when the distance H between the optical measuring device 30 and the measuring surface 38 of the measuring object 37 is changed.

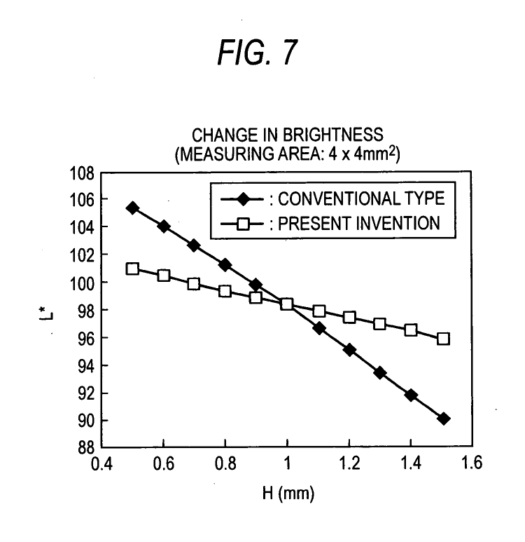

FIG. 7 is a graph showing the result of the above-mentioned experiment.

As is apparent from FIG. 7, even when the distance H between the optical measuring device 30 and the measuring surface 38 of the measuring object 37 is changed, the brightness L of the reflective light that the light-receiving elements 52 receive is substantially uniform around 99. Therefore, it has been known that the invention is capable of reducing the effect of the change in distance and improving the measurement precision, as compared with the related art of the optical measuring device.

### SECOND EMBODIMENT

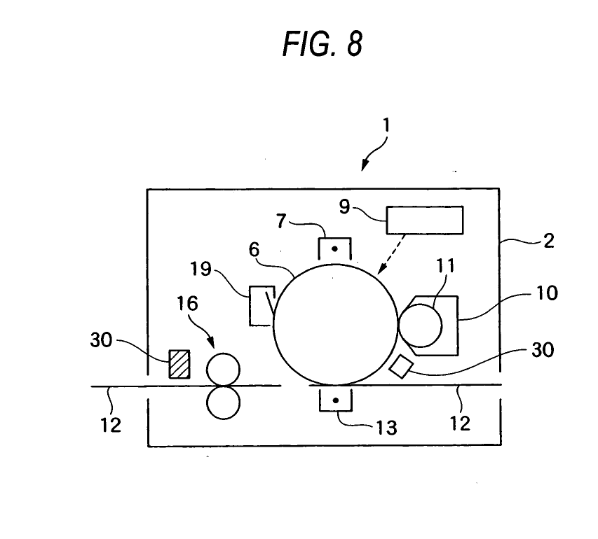

FIG. 8 illustrates a second exemplary embodiment of the invention, in which the same constituent elements as the first exemplary embodiment will be denoted by the same reference numerals. In the present embodiment, the optical measuring device is configured to measure the toner images formed on an image carrier, and the images formed on the paper. Also, the optical measuring device is of the 45/0 type that the illumination is performed from only one side.

As shown in FIG. 8, the image forming apparatus according to the second exemplary embodiment is configured so as to form images on the recording medium, that is, paper 12 which are cut in a predetermined size, rather than a long paper. Furthermore, the image forming apparatus 1 has an optical measuring device 30 that optically measures the toner images formed on the photosensitive drum 6 downstream of the developing device 10 on the surface of the photosensitive drum 6 serving as the image carrier. Furthermore, the image forming apparatus has an optical measuring device 30 that optically measures the images formed on the paper 12.

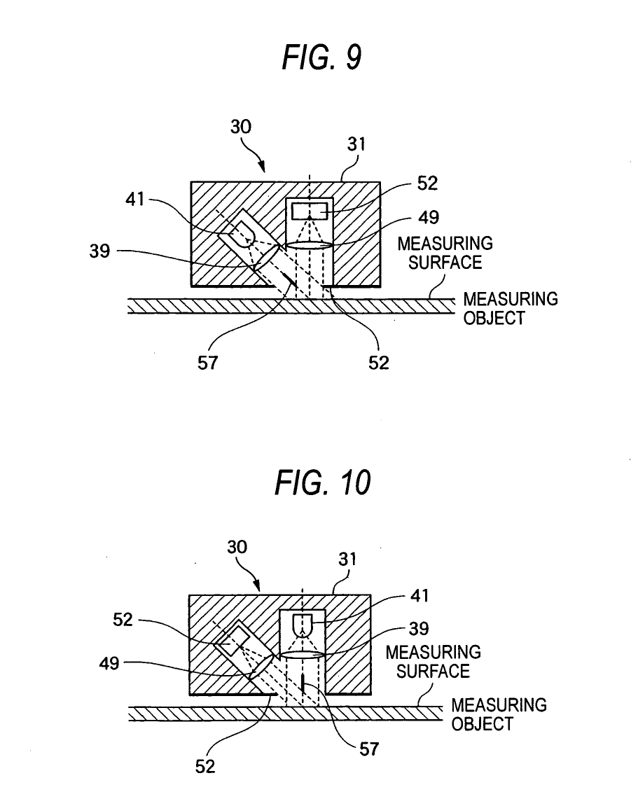

As shown in FIG. 9, in the optical measuring device 30, the light source 41 and the illuminating lens 39 are disposed only at one side slanted by 45° from the optical measuring device body 31, and the light-receiving lens 49 and the light-receiving elements 52 are disposed on the upper side of the optical measuring device body 31.

Furthermore, the optical measuring device 30 has the main aperture 52 that determines the illuminating area 53 by the illuminating lens 39, and a sub-aperture 57 that is formed at only one side corresponding to the illuminating lens 39. The measuring area 56 by the light-receiving lens is determined by the edge portion 54a of either the sub-aperture 57 or the main aperture 52.

The optical measuring device 30 according to the second exemplary embodiment includes a single light source 41 and a light-receiving element 52, so that its size can be reduced. Also, the optical measuring device 30 can be easily mounted on the circumference of the photosensitive drum 6 having a relatively small diameter.

Furthermore, in the second exemplary embodiment, the light source is disposed at a position slanted by 45° from the optical measuring device body 31, and the light-receiving element is disposed directly above the measuring object. The invention, however, is not limited thereto, and, as shown in FIG. 10, the light source 41 may also be disposed directly above (in the vertical direction) the measuring object, and the light-receiving element 52 may be of the 0/45 type that is disposed at a position slanted by 45° from the optical measuring device body 31.

It is noted that, in such case, the sub-aperture 57 is disposed directly above and perpendicular to the measuring object along the optical axis of the light source 41, and the measuring area 56 is determined by the lower portion of the sub-aperture 57 and the other edge portion 54a of the main aperture 52.

All other structures and effects of the second exemplary embodiment are the same as those of the first exemplary embodiment, and the explanation thereof will be omitted.

As described above, according to an aspect of the present invention, an optical measuring device measures optical characteristics of an object in a non-contact state. The optical measuring device has a light source that illuminates an object surface, a light receiver that receives a light beam reflected from the object surface, and a light-regulating member that regulates an illuminating light beam radiated onto the object surface and the reflective light beam reflected from the object surface. The light-regulating member has a first light-regulating member that determines at least one of an illuminating region and a reflective region with respect to the object surface, and a second light-regulating member that determines a region where the reflected light beam that is reflected from the object surface and is incident on the light receiver is measured on the object surface.

The first light-regulating member may be formed of a planar member disposed parallel to the object surface, and the first light-regulating member may have a shielding portion that shields a part of at least one of the illuminating light beam and the reflective light beam, and an opening portion that passes a part of at least one of the illuminating light beam and the reflective light beam.

The second light-regulating member may be formed of a thin planar member disposed substantially parallel to an optical axis of the illuminating light beam from the light source.

The optical measuring device may further have the plural light sources and the plural second light-regulating members which are the same number as the plural light sources. Each of the second light-regulating members may be formed of a thin planar member disposed substantially parallel to an optical axis of an illuminating light beam from each of the light sources.

An end portion of the second light-regulating member at an object surface side may be located at the substantially same position as the first light-regulating member at an object surface side.

The optical measuring device may measure at least one of an optical density and a reflectance of the object surface.

The light receiver may have a spectroscope and a light-receiving element.

According to another aspect of the present invention, an image forming device which forms an image on a recording medium includes an image carrier that carries an electrostatic latent image, a developing section that develops the latent image on the image carrier to form a toner image, a transfer section that transfers the toner image onto the recording medium, a fixing section that fixes the toner image transferred onto the recording medium, and an optical measuring section that measures optical characteristics of an image including the toner image fixed on the recording medium in a non-contact state. The optical measuring section includes a light source that illuminates an image surface including the toner image, a light receiver that receives a light beam reflected from the image surface, and a light-regulating member that regulates an illuminating light beam radiated onto the image surface and the reflective light beam reflected from the image surface. The light-regulating member has a first light-regulating member that determines at least one of an illuminating region and a reflective region with respect to the image surface, and a second light-regulating member that determines a region where the light beam that is reflected from the image surface and is incident on the light receiver is measured on the image surface.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical measuring device which measures optical characteristics of an object in a non-contact state, comprising:
a light source that illuminates an object surface;
a light receiver that receives a light beam reflected from the object surface; and
a light-regulating member that regulates an illuminating light beam radiated onto the object surface and the reflective light beam reflected from the object surface,
wherein the light-regulating member has a first light-regulating member that determines at least one of an illuminating region and a reflective region with respect to the object surface, and a second light-regulating member that determines a region where the reflected light beam that is reflected from the object surface and is incident on the light receiver is measured on the object surface.

2. The optical measuring device according to claim 1,
wherein the first light-regulating member is formed of a planar member disposed parallel to the object surface, and
the first light-regulating member has a shielding portion that shields a part of at least one of the illuminating light beam and the reflective light beam, and an opening portion that passes a part of at least one of the illuminating light beam and the reflective light beam.

3. The optical measuring device according to claim 1,
wherein the second light-regulating member is formed of a thin planar member disposed substantially parallel to an optical axis of the illuminating light beam from the light source.

4. The optical measuring device according to claim 1, further comprising:
a plurality of the light sources; and
a plurality of the second light-regulating members which are the same number as the plurality of light sources,
wherein each of the second light-regulating members is formed of a thin planar member disposed substantially parallel to an optical axis of an illuminating light beam from each of the light sources.

5. The optical measuring device according to claim 1,
wherein an end portion of the second light-regulating member at an object surface side is located at the substantially same position as the first light-regulating member at an object surface side.

6. The optical measuring device according to claim 1,
wherein the optical measuring device measures at least one of an optical density and a reflectance of the object surface.

7. The optical measuring device according to claim 1,
wherein the light receiver comprises a spectroscope and a light-receiving element.

8. An image forming device which forms an image on a recording medium, comprising:
an image carrier that carries an electrostatic latent image;
a developing section that develops the latent image on the image carrier to form a toner image;
a transfer section that transfers the toner image onto the recording medium;
a fixing section that fixes the toner image transferred onto the recording medium; and
an optical measuring section that measures optical characteristics of an image including the toner image fixed on the recording medium in a non-contact state,
wherein the optical measuring section includes:
a light source that illuminates an image surface including the toner image;
a light receiver that receives a light beam reflected from the image surface; and
a light-regulating member that regulates an illuminating light beam radiated onto the image surface and the reflective light beam reflected from the image surface,
wherein the light-regulating member has a first light-regulating member that determines at least one of an illuminating region and a reflective region with respect to the image surface, and a second light-regulating member that determines a region where the light beam that is reflected from the image surface and is incident on the light receiver is measured on the image surface.
